(19) United States
(12) Patent Application Publication
(10) Pub. No.: US 2008/0276002 A1
(43) Pub. Date: Nov. 6, 2008

(54) Traffic routing based on client intelligence

(75) Inventors: Linlong Jiang, Sunnyvale, CA (US); Michael F. Christian, Pacifica, CA (US)

Correspondence Address: HICKMAN PALERMO TRUONG & BECKER LLP/Yahoo! Inc., 2055 Gateway Place, Suite 550, San Jose, CA, 95110-1083, US

(73) Assignee: Yahoo! Inc.

(21) Appl. No.: 11/799,763

(22) Filed: May 1, 2007

(51) Int. Cl. G06F 15/16

(52) U.S. Cl. 709/241

(57) ABSTRACT

Techniques are described for making the best connection between a client and a server. The best connection is determined based upon the proximity of the client to the server, and the load and availability of the server. Proximity is determined by connection racing in which response times to requests made to various sets of servers are compared. The load is determined by back-end monitoring logic for each set of servers and is indicated in the response sent by the server. The availability of the server is monitored by a virtual IP server located with each set of servers. The virtual IP server selects available servers to respond to the request from the client. When the client receives responses, the client selects a server based on (a) the response times and (b) load information in the responses in order to make the best connection.

### FIELD OF THE INVENTION

The present invention relates to global traffic management on the Internet, and specifically to, connecting a client to a server in an efficient manner.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Internet services, such as a web site or a web application hosted in a single facility or geographic area may be subject to downtime due to general facility or network issues. Hosting in a single geographic area may result in high latency for clients whose network or geographic location is distant from the servers of the web application. Downtime at the data facility causes the web application to be unavailable to any user. Global server load balancing or “GSLB,” alleviates this problem by distributing client access to servers across a geographically distributed set of servers. Global server load balancing decreases the distance of servers to the users and allows connections to healthy servers should other servers or an entire data facility fail.

Global server load balancing may be implemented using a variety of techniques. These techniques may be based upon, but are not limited to, the domain name system or “DNS”, a directory server, and response time measurements.

The most common form of global server load balancing is based upon DNS. This is illustrated in FIG. 1. In this technique, two data centers, located in geographically distinct areas, contain large numbers of servers capable of hosting web applications. A client 105 wishes to connect to the web application hosted by the two data centers. For example, one data center might be located in New York 103 and the other data center might be located in San Francisco 101. The data center in New York 103 has a virtual IP address 1.2.3.4 and the data center in San Francisco 101 has a virtual IP address of 2.2.2.2. A virtual IP address is used for each data center so that a single IP address may be used to send a request to the particular data center rather than each server in the data center. If virtual IP was unavailable, individual requests would have to be made to each server in the data center, lessening the effectiveness of this technique. The DNS server then determines, based upon the client request for a web application, whether to return the IP address of 1.2.3.4 for New York or 2.2.2.2 for San Francisco.

However, problems arise when using DNS for global server load balancing. Internet service providers (ISPs) often have a centralized local name resolver that services their entire network. As used herein, a local name resolver, also called a recursive server, is a server that resides within an ISP's network and communicates with the ISP's users to service their DNS requests. The user communicates with the local name server, and then the local name server determines where to find that information. For example, in FIG. 1, user 105 sends a request 111 to local name resolver 107 comprising a domain name, such as “messenger.yahoo.com” The local name server 107 needs to ask the authoritative name server 109, which is the owner of “messenger.yahoo.com,” for the IP address of “messenger.yahoo.com.”

An authoritative name server 109 is a server that resides within and maintains data for the network of a domain. The authoritative name server 109 receives the request from a local name server and sends the local name server the IP address of the domain. In this example, the authoritative name server 109, located in Georgia, is also the GSLB and possesses the advanced logic to attempt to map the user intelligently. Under this circumstance, the authoritative name server and GSLB would reply to the local name server 107 with the IP address of either the data center located in San Francisco 101 or New York 103. Unfortunately, the authoritative name server and GSLB view the location of the local name resolver to be the location of the client, rather than the actual location of the client itself.

For example, a client 105 located in California with Acme Broadband as an internet service provider might make a request to connect to the Yahoo! Messenger server but is unaware of the location of the Yahoo! Messenger servers. Yahoo! Messenger servers are located in a data center in San Francisco 101 and a data center in New York 103. The client 105 makes a request 111 first to the Acme Broadband local name resolver 107 that is located in North Carolina. The local name resolver 107 then makes a request 1115 to the authoritative name server 109 of “messenger.yahoo.com” for the IP address of “messenger.yahoo.com.” The authoritative name server and GSLB 109 would view the request as originating from the location of Acme Broadband local name resolver 107 (North Carolina), and not from the location of client 105 (California). Thus, the authoritative name server and GSLB 109 would select a connection server based upon incorrect information. As used herein, a connection server is the actual server host or computer system that is identified by an IP address and accepts client connections to provide application logic. Thus, in this example, the much longer path to New York 119 would be selected rather than the shorter path from the client to San Francisco 117.

The authoritative name server and GSLB 109 respond to the local name server 107 with the IP address of the data center in New York 103. The local name server 107 sends the IP address of the data center in New York 103 to the client 105. Then, and only then, the client 105 connects 1 19 to the more distant servers in the data center in New York 103 and not the closer servers located in San Francisco 101.

A DNS-based GSLB also provides support for failover of a server and overload feedback. As used herein, failover of a server refers to the capability to switch over automatically to a redundant or standby server upon the failure or abnormal termination of the previously active server. Overload feedback, as used herein, refers to information from servers or a network indicating that the amount of work or network traffic exceeds a specified threshold and that connection requests should be made to a different server.

Unfortunately, DNS also has limitations with these features. When the GSLB server selects a connection server, the local name server, the operating system and a client application store the GSLB response in their respective caches. The GSLB response is stored so that the entire request process does not need to be replicated if the same request is made a short time later. The caches for the local name server, the operating system and the client application are independent of each other and store the GSLB response for a period of time. The GSLB server specifies an amount of time, a Time To Live or “TTL,” in which to store the GSLB response. Unfortunately, the caches for the local name server, the operating system and the client application may, and often will, ignore TTLs with a low value. Thus, the information in the GSLB response stored in the cache is often used long after the TTL has expired. Thus, upon a failover or overload of a server, the GSLB servers must propagate their changes throughout the network, which may take a lot of time.

Another problem with DNS associated with the caching mentioned above is that the GSLB server is unable to determine the number of clients that are behind a particular local name resolver. The GSLB server cannot determine if ten clients are behind the local name resolver or one million clients. This may profoundly affect the logic associated with proper load balancing. For example, if a GSLB server is unable to determine the number of clients behind a local name server, then the GSLB server would not be able to allocate, with precision, 50% of the requests to each of two data centers. This same problem occurs when the load on the connection servers in a data center must be decreased. If a GSLB server is unable to determine the number of clients behind a name server, then the GSLB server would not be able to remove only 10% of the load.

Another technique used in GSLB is based upon measurements recorded for response time. Berkeley Internet Name Domain, or “BIND,” an implementation of DNS protocols, may be used with this technique. For example, a Acme Broadband local name resolver might communicate with a connection server's DNS servers. BIND would measure the response time of a first server to respond. If BIND determines that the response time of the first server is too long, then BIND sends a request to a second server and measures the response time of the second server. By continuing to measure the response times of various servers, BIND maintains a map of servers that perform well and servers that perform poorly. However, GSLB response times are not an indicative measurement of application server load.

Another approach that may be employed for GSLB is based upon directory server. In this technique, a client queries a directory server for an IP address of the connection server in which to connect. Load distribution and failover may be implemented in the directory server logic. Unfortunately, no client proximity information is used with this technique.

As a result, there is a clear need for techniques that provide a connection to a server based on proximity, load, and availability that do not present the limitations of the above techniques.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a technique of global server load balancing based upon DNS;

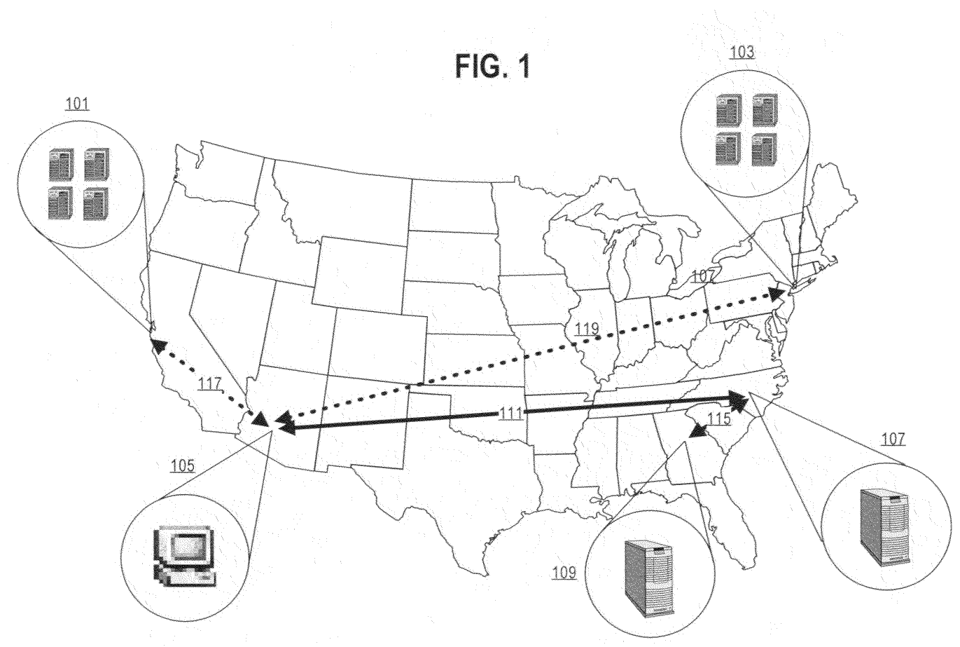

FIG. 2 is a diagram of a process, according to an embodiment of the invention, performed by a client to select the best server;

FIG. 3 is a flow diagram of a process that a client performs in order to connect to a connection server, according to an embodiment of the invention;

FIG. 4 is a flow diagram of a process that servers perform in order to process capacity requests and connection requests from a client, according to an embodiment of the invention; and

FIG. 5 is a block diagram of a computer system on which embodiments of the invention may be implemented.

### DETAILED DESCRIPTION

Techniques are described for a client to connect to a server while taking into account the proximity of the client to the server and the load and availability of the server. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

In an embodiment, a client is modified in order to implement a more sophisticated routing system that does not rely upon DNS or any of the other previously mentioned global service load balancing solutions. In addition, the logic of the servers are enhanced to provide additional information to the client and to monitor the health of the connection servers. By modifying both the client and the server, the best possible connection can be made based on the proximity of the client and the server, the load of the server, and the health of the server.

### Sending a Capacity Request

A client on a user's computer is modified in order to make the best connection to a server. In an embodiment, the client is pre-populated with a list of colocations to connect to a connection server. As used herein, a colocation is a data center that houses, in a distinct geographic area, a large number of connection servers to which a client may connect. The list is actually a list of Internet Protocol (IP) addresses for each of the colocations. The list is provided as IP addresses, and not domain names, so that the client connects directly with each colocation and bypasses the name resolver. As mentioned previously, if the client connects via a name resolver, then a DNS server determines the connection by the location of the name resolver and not by the location of the client. If the name resolver and the client are in close proximity, then the results are not problematic. Unfortunately, in many cases, the physical location of the name resolver and the client varies considerably.

In an embodiment, the client determines which of the colocations are closest to the client. As used herein, “close” does not necessarily mean basing the determination only on geographic proximity. As used herein, a “close” colocation is a colocation which results in the fastest connection to the client. Thus, if a colocation that was located 100 miles away were slower for the client to reach than a colocation located 200 miles away because of heavy congestion, then the client would select the colocation 200 miles away.

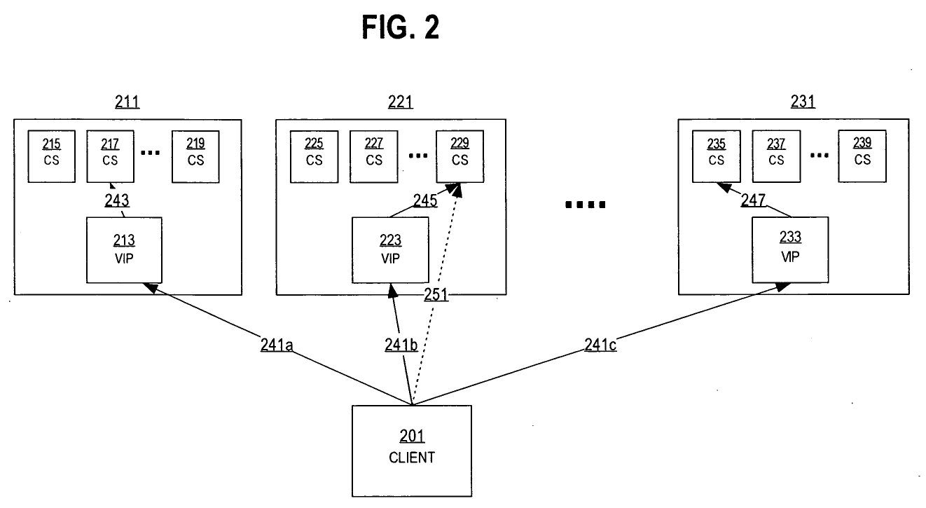

In an embodiment, the client determines the colocation to which to connect based upon connection racing. FIG. 2 illustrates the process of a client connecting to a server, according to an embodiment of the invention. A client 201 first sends capacity requests in parallel to connect to all colocations 211, 221, and 231 on the pre-populated IP list simultaneously. Capacity requests, as used herein, are requests made by a client to determine (a) the health and load in a colocation and (b) the IP address of a particular connection server to which to connect. In FIG. 2, three simultaneous capacity requests are made. Request 241a is made to the first colocation 211. Request 241b is made to the second colocation 221. Request 241c is made to the third colocation 231. Other colocations may be present, and are represented by the ellipses between the second colocation 221 and the third colocation 231. In an embodiment, client 201 sends capacity requests simultaneously to only select colocations on the pre-populated IP list. This may occur if client 201 is located in a geographically isolated region and if sending requests to far more distant colocations would not be effective. In yet another embodiment, the selection of which colocations to send requests is based upon feedback from some colocations that some colocations are unavailable or overloaded. Under such circumstances, client 201 may refrain from sending requests to the overloaded colocations.

### Server Responds to Request

In one embodiment, each colocation comprises one or more connection servers and a virtual IP, or “VIP,” server. In the example shown, the first colocation 211 comprises connection servers 215, 217, and 219, and VIP server 213. The second colocation 221 comprises connection servers 225, 227, and 229, and VIP server 223. The third colocation 231 comprises connection servers 235, 237, and 239, and VIP server 233.

The client's capacity requests are directed to the VIP server of each colocation. Each colocation is identified by a VIP so that all attempted connections to a particular colocation are made with a single IP address for that particular colocation. A VIP is an IP address that is not connected to a specific connection server. VIPs are used mostly for connection redundancy. Each connection server within the colocation also is associated with an individual IP address that is publicly reachable independent of the VIP server.

When client 201 sends requests 241a, 241b, and 241c to the colocations, VIP servers 213, 223, and 233 serve each capacity request for best reliability. Each VIP server monitors the health of all connection servers in that VIP server's colocation and selects healthy connection servers to handle capacity requests as well as subsequent persistent connections. In FIG. 2, VIP server 213 for first colocation 211 sends the capacity request to connection server 217 as request 243. VIP server 223 for second colocation 221 sends the capacity request to connection server 229 as request 245. VIP server 233 for third colocation 231 sends the capacity request to connection server 235 as request 247.

In each colocation, back-end load aggregation and monitoring logic feeds capacity information for the colocation to each individual connection server. In an embodiment, the response from the connection server indicates the availability of the colocation and the IP address of a particular connection server. The availability may be given in a variety of forms. The availability may be as simple as “yes” or “no,” or may provide more choices such as “yes,” “no,” or “busy.” “Yes” indicates that the colocation is available to handle the request. “No” indicates that the colocation is unable to handle the request. Reasons for a “no” may be, but are not limited to, the colocation being overwhelmed with requests or detecting an error. “Busy” indicates that the colocation does have the capacity to handle the request, if necessary, but would prefer not to handle the request. In another embodiment, the connection server indicates different levels of “willingness,” presented in percentage terms, to accept the request. A willingness of 0% would indicate “no” availability. A willingness of 100% would mean the connection server is available and reply “yes.” All numbers in between would reply “busy” with willingness increasing as the percentage increases.

In another embodiment, back-end load aggregation and monitoring logic feeds capacity information for the colocation to the VIP server. When a capacity request is received from a client, the VIP sends a response directly with the capacity information for the colocation along with the IP address of a healthy connection server. The capacity request is not forwarded to individual connection servers for a response. The VIP continues to monitor the health of the connection servers in the colocation.

In an embodiment, the formulation of the responses from the colocation is at least, in part, controlled by the system administrator. For example, the system administrator might wish to keep the load of all of the connection servers at the colocation at a specified capacity. If the colocation reaches that capacity, then the response by a connection server to the capacity request would be “no” or “busy.” The system administrator may adjust the limits of the colocation loads to best fit the needs of the host.

In another embodiment, a colocation is configured with load limits corresponding to values for low and high watermarks. If the colocation load is below the value for the low watermark, then the response from the server to a capacity reply is “yes.” If the load of the colocation is between the values for the low and high watermarks, then the reply is “busy.” If the load reaches or exceeds the value for high watermark, then the reply would be “no.”

In an embodiment, the IP address in the response is the IP address of the particular connection server so that client 201 may later connect directly with the connection server when the client makes a connection request. The response sent to client 201 indicates the IP address of the connection server which served the capacity request. In another embodiment, the response sent to client 201 indicates an IP address of a connection server which did not serve the capacity request, but is capable of handling the next connection.

In an embodiment, the connection server directly sends the response to the capacity server request. In another embodiment, the connection server passes the response to the VIP, which then sends the response to client 201.

### Connection Racing and Client Selection

Each colocation 211, 221, and 231 sends a response based upon the capacity request back to client 201. In one embodiment, to determine the proximity of the servers to client 201, connection racing is employed. In connection racing, client 201 measures the amount of time required for each colocation to respond to the client's request. Because client 201 sent the requests simultaneously, whichever colocation response reaches client 201 first is deemed to be the closest. The second response received is deemed to be second closest, and so on. If a response from a colocation does not arrive, then this may indicate that the colocation has failed or that the network to the colocation is unreliable.

As mentioned previously, the response to the capacity request indicates the availability of the colocation and an IP address of a particular connection server. The availability of the colocation indicates the load capacity of the colocation. An answer of “yes” indicates that the load at the colocation is in a range that allows additional connections. The IP address of the particular connection server indicates that the connection server is healthy. The VIP server of the colocation monitors the health of the connection servers in the colocation and serves requests to only healthy servers. In an embodiment, client 201 selects a colocation based upon the availability of the colocation and the response time of the response to the capacity request. By selecting based on those criteria, client 201 makes a best selection of a connection server based on the proximity of the client to the server (found by connection racing), the capacity or load of the server (indicated by availability in the response), and the health of the server (indicated by the IP address in the response).

In an embodiment, client 201 connects directly to the connection server indicated by the response. This is shown by the dotted connection 251 in FIG. 2. In another embodiment, client 201 may select only a colocation (rather than a specific connection server) and connect using the colocation's virtual IP. The VIP server of the colocation then selects a particular healthy connection server and connects client 201 to the particular connection server.

In an embodiment, if a colocation or an individual connection server fails, then client 201 performs the connection process once again to form a new connection with a connection server. In an embodiment, this technique is employed in cases of a persistent TCP connection between the client and the server, such as that found in network instant messaging applications. In another embodiment, this technique may be used for any client and server connection that relies on persistent connections. In yet another embodiment, the technique may be used for any client and server connection that relies on a transient connection.

### Overview of Client Operation

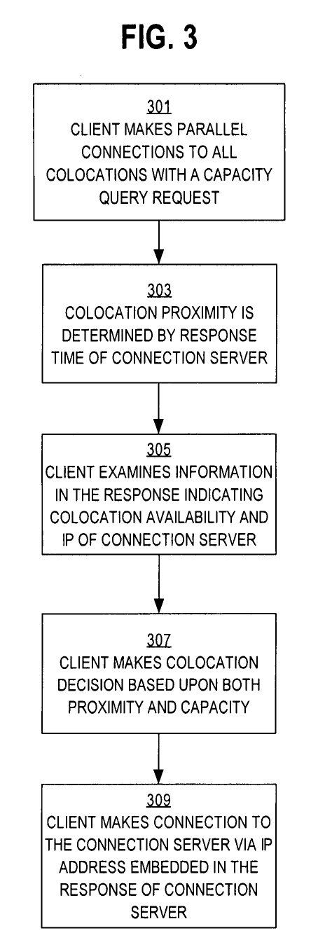

FIG. 3 illustrates the actions a client performs in order to connect to a connection server, according to an embodiment of the invention. In step 301, the client performs connection racing in order to determine the closest server to the client. Connection racing is performed by the client attempting parallel connections to all colocations with a capacity query request.

The client receives responses and compares the response times from the different colocations in order to determine the proximity of the colocations to the client as shown in step 303. The colocation with the shortest response time has the closest proximity to the client. In step 305, the client examines the information in the response from the colocation. The information indicates the availability of the colocation and an IP address of a connection server in that colocation. The availability may be shown as “yes” or “no,” with “yes” indicating that the colocation may accept new client connections and “no” indicating that the colocation is not accepting new client connections.

The client then determines the colocation to which to connect based upon the proximity and the capacity of each responding colocation in step 307. The proximity is determined by the connection racing. The capacity is determined by the availability information in the response. The availability is determined by the load or capacity of the colocation. Finally, in step 309, the client makes a connection to the connection server using the IP address indicated in the response.

### Overview of Server Operation

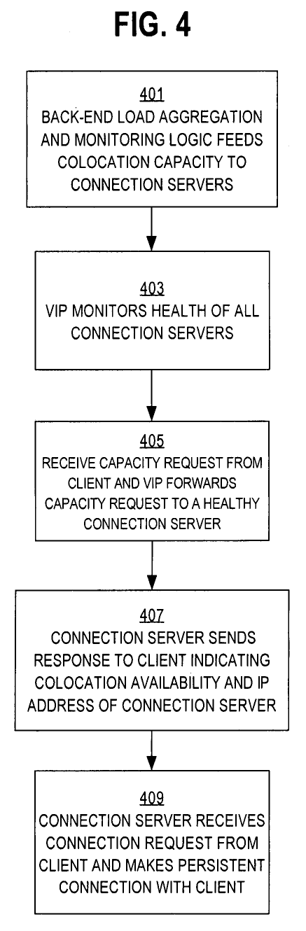

FIG. 4 illustrates the actions that the servers perform in order to respond to a client, according to an embodiment of the invention. First, in order to provide accurate information about the colocation, information about the colocation is sent to each connection server. In step 401, back-end load aggregation and monitoring logic sends capacity for the colocation to each connection server. Also, the VIP server for each colocation performs ongoing monitoring of the health of the connection servers in that location as shown in step 403.

In step 405, the colocation receives a capacity request from a client. The VIP server of the colocation forwards the request to a healthy connection server. In step 407, the connection server sends a response to the capacity request. The response includes the capacity of the colocation and the IP address of the individual connection server. Finally, if the colocation is selected by the client (based upon various criteria), then the connection server will receive a request made using the connection server's IP address (as indicated in the response), as shown in step 409. A persistent connection is then made with the client and the server.

### Hardware Overview

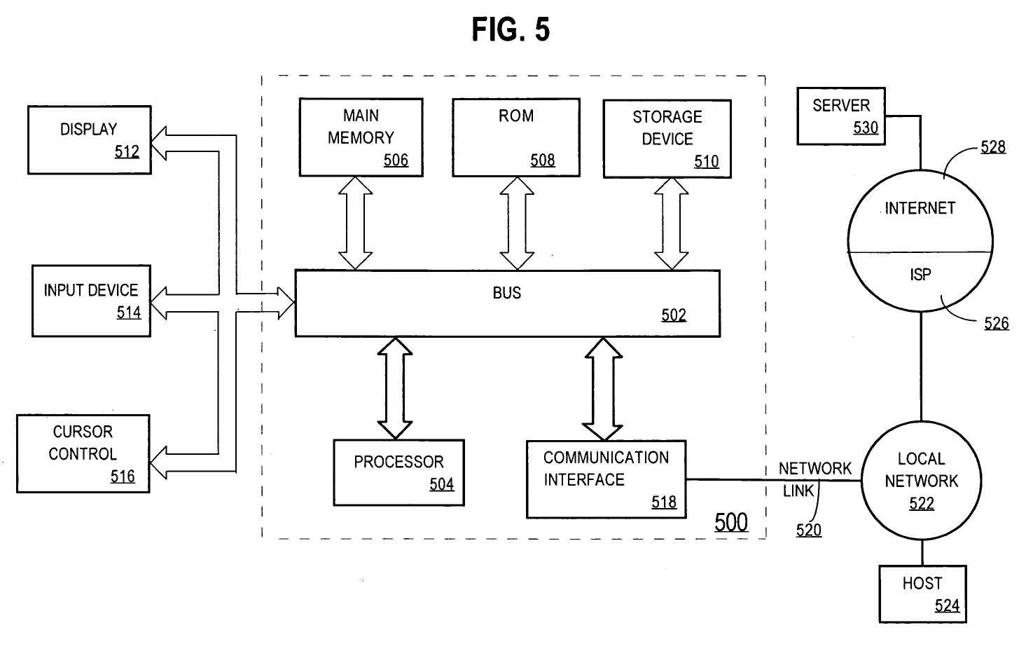

FIG. 5 is a block diagram that illustrates a computer system 500 upon which an embodiment of the invention may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein. According to one embodiment of the invention, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 500, various machine-readable media are involved, for example, in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution. In this manner, computer system 500 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method to connect to a server, comprising:
for each set of servers in a plurality of sets of servers, sending a request to the set of servers;
receiving, from two or more set of servers in the plurality of sets of servers, two or more responses to said request;
wherein at least one response of the two or more responses indicates information regarding an availability of a server in a set of servers from which the at least one response originated;
comparing a first amount of time taken to receive a first response of the two or more responses to a second amount of time taken to receive a second response of the two or more responses;
selecting, based at least in part on the comparing and the information, a particular server from among servers in the plurality of sets of servers; and
connecting to the particular server.

2. The method of claim 1, wherein a virtual IP server monitors the availability and health of the servers within the set of servers.

3. The method of claim 2, wherein the virtual IP server selects a server to handle the request.

4. The method of claim 1, wherein the requests are sent to IP addresses from a pre-populated list of IP addresses.

5. The method of claim 1, wherein the request originates from a client residing on the user's computer.

6. The method of claim 5, wherein the client is a stand alone application on the user's computer.

7. The method of claim 1, wherein availability of the server in a set of servers is based upon information sent by a backend load monitoring component to each server in the set of servers.

8. The method of claim 1, wherein the response is received from a server in the set of servers.

9. The method of claim 2, wherein the response is received from the virtual IP server of the set of servers.

10. A system comprising,
a client; and
a plurality of sets of servers, wherein
for each set of servers in the plurality of sets of servers, the client sends a request to the set of servers;
in response to the request by the client, each set of servers sends a response that indicates information regarding an availability of a server in the set of servers;
receiving at the client, from two or more set of servers in the plurality of sets of servers, two or more responses to said request;
the client compares a first amount of time taken to receive a first response of the two or more responses to a second amount of time taken to receive a second response of the two or more responses;
the client selecting, based at least in part on the comparing and the information, a particular server from among servers in the plurality of sets of servers; and
the client connects to the particular server.

11. The method of claim 10, wherein a virtual IP server monitors the availability and health of the servers within the set of servers.

12. The method of claim 11, wherein the virtual IP server selects a server to handle the request.

13. The method of claim 10, wherein availability of the server in a set of servers is based upon information sent by a backend load monitoring component to each server in the set of servers.

14. The method of claim 10, wherein the client is a stand alone application on a user's computer.

15. A machine-readable storage medium carrying one or more sequences of instructions which, when executed by one or more processors, causes the one or more processors to perform the method recited in claim 1.

16. A machine-readable storage medium carrying one or more sequences of instructions which, when executed by one or more processors, causes the one or more processors to perform the method recited in claim 2.

17. A machine-readable storage medium carrying one or more sequences of instructions which, when executed by one or more processors, causes the one or more processors to perform the method recited in claim 3.

18. A machine-readable storage medium carrying one or more sequences of instructions which, when executed by one or more processors, causes the one or more processors to perform the method recited in claim 4.

19. A machine-readable storage medium carrying one or more sequences of instructions which, when executed by one or more processors, causes the one or more processors to perform the method recited in claim 5.

20. A machine-readable storage medium carrying one or more sequences of instructions which, when executed by one or more processors, causes the one or more processors to perform the method recited in claim 6.

21. A machine-readable storage medium carrying one or more sequences of instructions which, when executed by one or more processors, causes the one or more processors to perform the method recited in claim 7.

22. A machine-readable storage medium carrying one or more sequences of instructions which, when executed by one or more processors, causes the one or more processors to perform the method recited in claim 8.

23. A machine-readable storage medium carrying one or more sequences of instructions which, when executed by one or more processors, causes the one or more processors to perform the method recited in claim 9.

24. A machine-readable storage medium carrying one or more sequences of instructions which, when executed by one or more processors, causes the one or more processors to perform the method recited in claim 10.

25. A machine-readable storage medium carrying one or more sequences of instructions which, when executed by one or more processors, causes the one or more processors to perform the method recited in claim 11.

26. A machine-readable storage medium carrying one or more sequences of instructions which, when executed by one or more processors, causes the one or more processors to perform the method recited in claim 12.

27. A machine-readable storage medium carrying one or more sequences of instructions which, when executed by one or more processors, causes the one or more processors to perform the method recited in claim 13.

28. A machine-readable storage medium carrying one or more sequences of instructions which, when executed by one or more processors, causes the one or more processors to perform the method recited in claim 14.
